(19) United States
(12) Patent Application Publication
(10) Pub. No.: US 2003/0123797 A1
(43) Pub. Date: Jul. 3, 2003

(54) Variable dispersion compensator and substrate for the same

(76) Inventors: Minoru Hashimoto, Tokyo (JP); Kiichi Yoshiara, Tokyo (JP); Takuya Ohhira, Tokyo (JP); Sadayuki Matsumoto, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/173,872

(22) Filed: Jun. 19, 2002

(30) Foreign Application Priority Data
Dec. 27, 2001 (JP) 2001-396514

(51) Int. Cl. G02B 6/34; G02B 5/18

(52) U.S. Cl. 385/37; 359/566

(57) ABSTRACT

A variable dispersion compensator comprises a substrate, a fiber grating, and a plurality of heater elements. Main heater elements are arranged in a grating range of the fiber grating. A sub-heater element is arranged within the grating range of the fiber grating. Heat from the sub-heater element is used to correct a temperature distribution produced by the main heater elements in the fiber grating to achieve a linear temperature distribution.

### FIELD OF THE INVENTION

The present invention relates to an apparatus for compensating dispersion in an optical signal by imparting a temperature distribution on a chirp grating.

### BACKGROUND OF THE INVENTION

An optical fiber communication system can transmit a large amount of information at a high speed. The optical fiber communication system comprises an optical signal source, an optical fiber transmission line for transmitting optical signals and an optical receiver for detecting and demodulating the optical signals. When an optical signal with a certain wavelength range is employed, a longer wavelength component has a lower propagation velocity than that of a shorter wavelength component and causes a delay. This delay time deteriorates a signal waveform. If a large number of channels are employed over a wide wavelength range, it is required to accurately compensate a difference (dispersion) between such the propagation velocities.

The dispersion compensation can be achieved through the use of a chirp grating. The chirp grating is located at the mid-portion in an optical fiber transmission path to reflect optical signals such that a shorter wavelength light passes through a longer path than a path through which a longer wavelength light passes. Negative wavelength dispersion is given to the optical signal when the shorter wavelength light passes through a longer path than a path through which the longer wavelength light passes. The negative wavelength dispersion is effective to compensate the dispersion occurred in the optical signal. When λB is used to denote a wavelength reflected at a grating (Bragg wavelength), Neff an effective index of the grating, and Λ a pitch in the grating, λB can be given from the following equation,

λB=2·Neff·Λ (1)

A linear variation in the grating pitch Λ can change the Bragg wavelength λB linearly. A linear reduction of the grating pitch Λ gradually from the incident side of the optical signal can achieve linear negative dispersion.

Various external factors affect on the optical fiber that is employed to configure the transmission path. Major external factors include temperatures and stresses. When a local variation in temperature or stress arises in the optical fiber, it varies the refractive index of the optical fiber. Variation in the refractive index of the optical fiber yields new dispersion in the optical signal, which cannot be compensated by a stationary grating.

Japanese Patent Application Laid-Open No. 2000-235170 discloses a variable dispersion compensator. The variable dispersion compensator disclosed in this publication comprises a plurality of micro-heaters provided on a fiber grating. Powers supplied to the micro-heaters are each adjusted to form an arbitrary temperature distribution over the length of the fiber grating. This temperature distribution varies the refractive index Neff of the grating to finely adjust the Bragg wavelength λB, compensating the dispersion in the optical signal.

The micro-heaters are located in a grating range of the fiber grating. Adjustment of heating values of the heaters can impart a desired temperature distribution on the fiber grating. In the fiber grating a location of a heater element sandwiched between other heater elements has a temperature not sharply changed but stabilized because a heat input from the higher temperature side interacts with a heat output to the lower temperature side. In contrast, an end portion has no heat input from adjacent heater element and also has a large temperature difference from a location provided with no heater, resulting in a sharp heat output. The sharp heat output invites an unstable temperature and disruptive temperature distribution. Even if plural heater elements are employed to impart a linear temperature distribution on the fiber grating, the sharp heat output produces a non-linear temperature at the higher temperature end. Accordingly, it is difficult to achieve a linear temperature distribution over the whole grating range of the fiber grating. The same problem arises when a non-linear temperature distribution is to be created over the whole grating range of the fiber grating. Thus, it is difficult to achieve a desired temperature distribution over the whole grating range of the fiber grating.

### SUMMARY OF THE INVENTION

It is an object of this invention to provide an apparatus capable of-achieving a desired temperature distribution over the whole grating range of a fiber grating or a chirp grating.

The variable dispersion compensator according to one aspect of this invention comprises a substrate, a fiber grating arranged on the substrate, a plurality of main heater elements arranged along the axis of the fiber grating within a grating range of the fiber grating, and a sub-heater element arranged beyond the grating range of the fiber grating for adjusting a temperature distribution of in the fiber grating produced by the main heater elements.

The variable dispersion compensator according to another aspect of this invention comprises a substrate, a chirp grating arranged on the substrate, a main heating unit arranged along the axis of the chirp grating within a grating range of the chirp grating, and a sub-heating unit arranged beyond the grating range of the chirp grating.

The variable dispersion compensator according to still another aspect of this invention comprises a substrate, a fiber grating arranged on the substrate, a plurality of first heater elements arranged along the axis of the fiber grating, and a plurality of second heater elements arranged along the axis of the fiber grating and spaced from the first heater elements. The first heater elements impart a linear temperature distribution on the fiber grating, and the second heater elements impart a non-linear temperature distribution on the fiber grating.

The variable dispersion compensator according to still another aspect of this invention comprises a substrate, a chirp grating arranged on the substrate, a first heating unit arranged along the axis of the chirp grating which creates a linear temperature distribution in the chirp grating, and a second heating unit arranged along the axis of the chirp grating and spaced from the first heating unit which creates a non-linear temperature distribution in the chirp grating.

The variable dispersion compensator according to still another aspect of this invention comprises a substrate, a fiber grating arranged on the substrate, and a plurality of heater elements arranged along the axis of the fiber grating in a region other than the region in the fiber grating where the temperature is the lowest.

The variable dispersion compensator according to still another aspect of this invention comprises a substrate, a chirp grating arranged on the substrate, a heating unit which imparts a temperature distribution on the chirp grating except for the lowest temperature along the axis of the chirp grating, and a substrate temperature control unit located beneath the substrate which evens temperatures of the substrate and imparts the lowest temperature to the substrate.

The substrate for a variable dispersion compensator according to still another aspect of this invention comprises a plurality of main heater elements arranged in line, and a sub-heater element arranged in the vicinity of the main heater elements. The sub-heater element adjusts a temperature distribution in the fiber grating produced by the main heater elements.

The substrate for a variable dispersion compensator according to still another aspect of this invention comprises a plurality of first heater elements arranged in line, and a plurality of second heater elements arranged in parallel with and spaced from the first heater elements. The first heater elements impart a linear temperature distribution on the fiber grating, and the second heater element impart a non-linear temperature distribution on the fiber grating.

Other objects and features of this invention will become apparent from the following description with reference to the accompanying drawings.

### BRIEF DESCRIPTION OF THE DRAWINGS

FIG. 1 is a diagram showing a configuration of an optical fiber communication system,

FIG. 2 is a block diagram showing a configuration of an optical dispersion compensator in FIG. 1,

FIG. 3 is a perspective view of a fiber grating heater unit in FIG. 2,

FIG. 4 shows how the fiber grating heater unit is produced,

FIG. 5 shows how the fiber grating heater unit is produced,

FIG. 6 shows a relation between a fiber grating and heater elements in the fiber grating (FG) heater unit,

FIG. 7 shows a relation between a heater location and a temperature distribution in the fiber grating,

FIG. 8 shows a relation between a wavelength of an optical signal and a group delay time,

FIG. 9 shows positions of a fiber grating, heater elements and a substrate in the FG heater unit,

FIG. 10 shows a relation between a heater location and a temperature of a fiber grating,

FIG. 11 shows positions of the fiber grating, main heater elements, a sub-heater element and a substrate in the FG heater unit,

FIG. 12 is a graph which shows a relation between a heater location in the FG heater unit and a temperature of the fiber grating in FIG. 11,

FIG. 13 shows positions of the fiber grating, heater elements and the substrate in another FG heater unit,

FIG. 14 is a perspective view of a further FG heater unit,

FIG. 15 is a plan view of the FG heater unit shown in FIG. 14,

FIG. 16 is a graph which shows a relation between a heater location in the FG heater unit and a temperature of the fiber grating shown in FIG. 14,

FIG. 17 is a graph which shows a relation between a heater location in the FG heater unit and a temperature of the fiber grating shown in FIG. 14,

FIG. 18 is a graph which shows a relation between a heater location in the FG heater unit and a temperature of the fiber grating shown in FIG. 14,

FIG. 19 is a plan view of another FG heater unit, and

FIG. 20 is a plan view of another FG heater unit.

### DETAILED DESCRIPTION

Embodiments of the present invention will be described below with reference to the accompanying drawings.

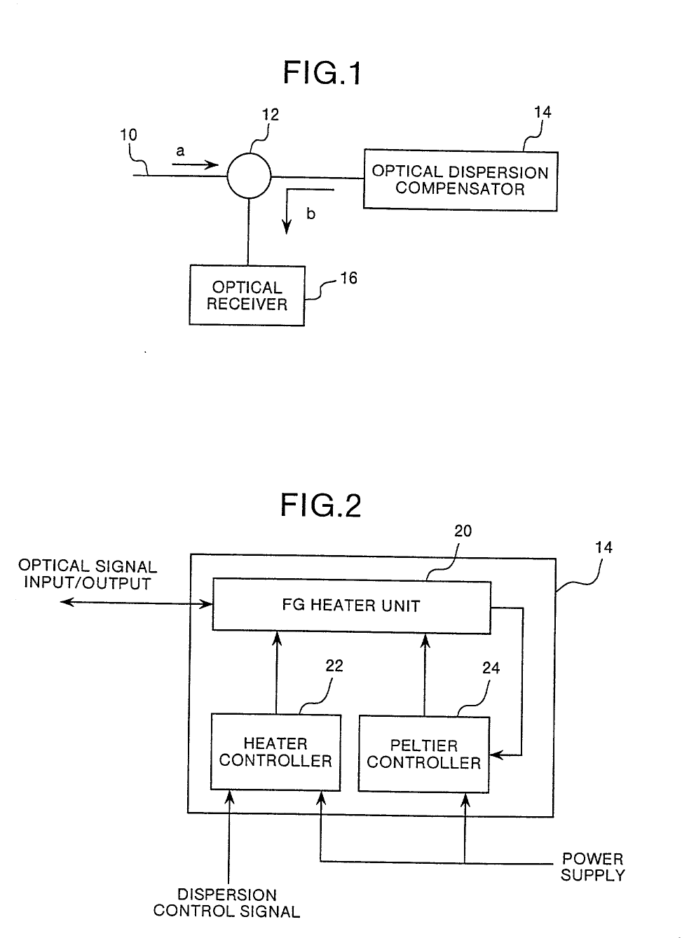

FIG. 1 shows an optical fiber communication system according to an embodiment. An optical signal from a source, not depicted, is transmitted through an optical fiber transmission path 10 to a circulator 12. The circulator 12 is coupled to an optical dispersion compensator 14 through the optical fiber transmission path 10. The optical signal separated at the circulator 12 is supplied to the optical dispersion compensator 14 through the optical fiber 10 as indicated by the path-a. The optical dispersion compensator 14 is employed to compensate dispersion in the input optical signal. The optical signal, dispersion-compensated and reflected at the optical dispersion compensator 14, reenters the circulator 12. The optical signal, dispersion-compensated and entering the circulator 12, is supplied to an optical receiver 16 as indicated by the path-b. The optical receiver 16 is employed to detect and demodulate the input optical signal. The optical dispersion compensator 14 is a variable dispersion compensator, which comprises a fiber grating and a heater. The heater produces heat for giving a desired temperature distribution in the fiber grating to impart a desired variation in the effect index Neff of the fiber grating. Other than the variable dispersion compensator 14, a stationary dispersion compensator may also be provided in the optical fiber transmission path. In this case, the stationary dispersion compensator is employed to roughly compensate the dispersion in the optical signal, which is then finely compensated in the variable dispersion compensator 14.

FIG. 2 is a block diagram which shows a configuration of the optical dispersion compensator 14 in FIG. 1. The optical dispersion compensator 14 comprises a fiber grating (FG) heater unit 20, a heater controller 22 and a Peltier controller 24. The optical signal from the circulator 12 enters the FG heater unit 20. The optical signal is Bragg-reflected at the FG heater unit 20 and reenters the circulator 12. The FG heater unit 20 includes a plurality of heater elements arranged in line. An amount of heat from each heater element is controlled at the heater controller 22. The heater controller 22 is employed to adjust a power supplied to each heater element based on a dispersion control signal from a controller, not depicted. More specifically, the heater controller 22 adjusts an amount of a current supplied to each heater element. The FG heater unit 20 is provided with a Peltier unit in addition to the heater elements. An amount of heat from the Peltier unit is controlled at the Peltier controller 24. The Peltier controller 24 feedback-controls the Peltier unit based on a signal indicating substrate temperature from the FG heater unit 20 to keep a uniform and constant substrate temperature. Drive powers for the heater controller 22 and the Peltier controller 24 are supplied from external.

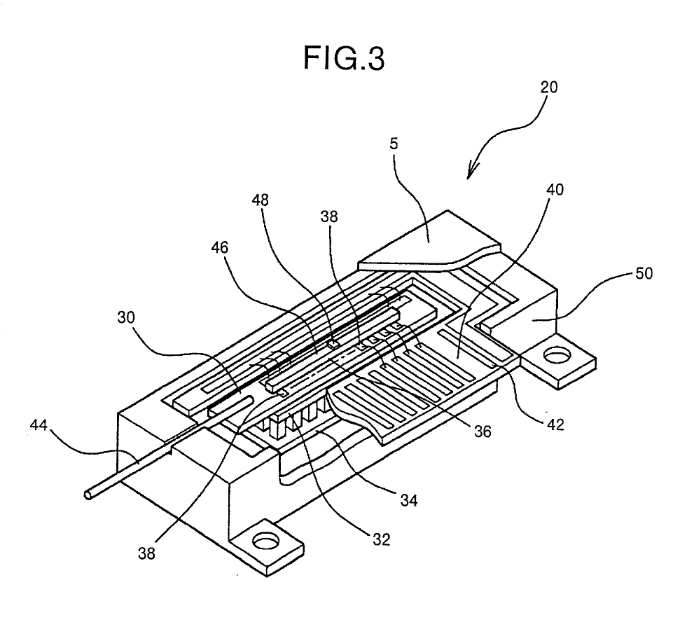

FIG. 3 shows the FG heater unit 20 in a perspective view. Plural heater elements 36 are formed on the surface of a quartz substrate 30 in line along the axis of a fiber grating 44. The quartz substrate 30 has a low thermal conductivity effective to suppress thermal diffusion from the heater elements 36. In this embodiment the substrate 30 employs a quartz material as a non-limited example and may also be composed of a different material. Preferably, such the different material has a low thermal conductivity, for example, of 0.005 W/mm° C. or less. The heater elements 36 are split into 34 pieces in this example. The heater elements 36 are required to have such conditions that include a small area of each element, a large number of the elements and a small element interval. Each of the heater elements 36 is connected to each of electrodes 38. The electrodes 38 are arranged in two electrode arrays that sandwich the heater elements 36 therebetween. The electrodes 38 are bonded via wires to terminals 42 formed on a relay substrate 40. The fiber grating 44 is fixed at a certain location on the substrate 30 with a cap 46 for securing the fiber grating. A thermistor 48 is formed on the upper surface of the cap 46 for securing the fiber grating. The thermistor 48 is employed to detect a temperature of the cap 46 or a temperature of the quartz substrate 30, which is supplied to the Peltier controller 24. A Peltier unit 34 is provided beneath the quartz substrate 30 interposing a heat spreader 32 therebetween. The Peltier unit 34 radiates or absorbs heat when a current flows through it. Therefore, it is employed to set uniform and constant temperatures of the quartz substrate 30. The quartz substrate 30, the heat spreader 32 and the cap 46 for securing the fiber are housed in a case 50. The case 50 has a cover 5 for tightly sealing inside. The fiber grating 44 extends outwardly through a groove formed in the case 50. The fiber grating 44 is coupled to the optical fiber transmission path 10, which is in turn coupled to the circulator 12.

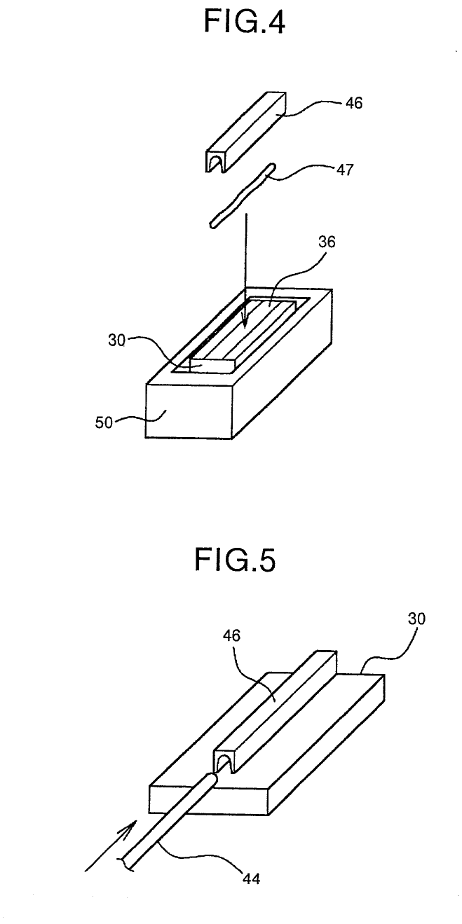

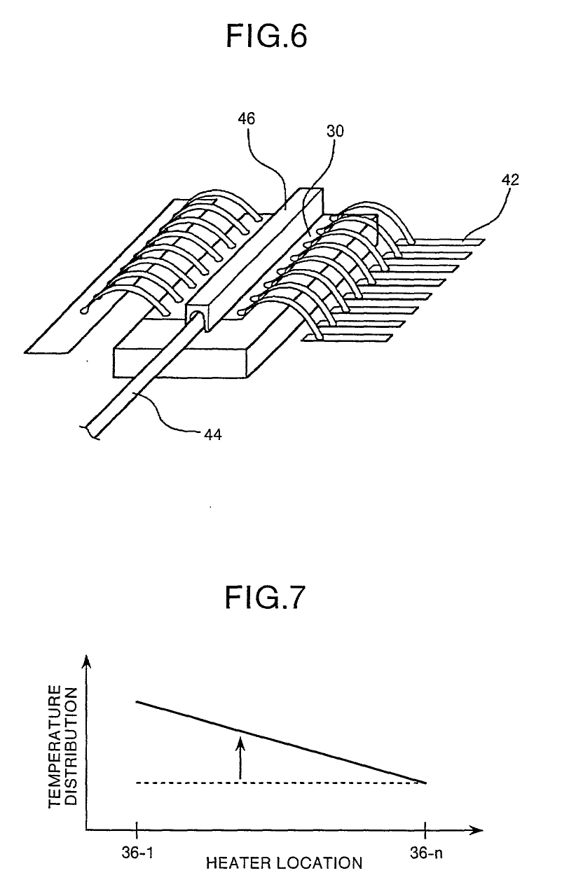

FIG. 4 to FIG. 6 show an example of a method of producing the FG heater unit 20. The heater elements 36 are patterned first on the surface of the quartz substrate 30. The electrodes 38 are also patterned simultaneously with the heater elements 36. The cap 46 is then positioned relative to the heater elements 36 to secure the cap 46 on the quartz substrate 30. The cap 46 has a straight groove formed therein for receiving the fiber grating 44 inserted therein. A silicone gel 47 is filled within the groove in the cap 46. The silicone gel 47 can be obtained in the process of modifying a liquid silicone to a solid form by halting the reaction. The silicone gel 47 is filled in a gap formed between the fiber grating 44 and the groove in the cap 46. The silicone gel 47 has a low hardness effective to decrease a stress applied to the fiber grating 44. The silicone gel 47 creates a uniform thermal distribution between the fiber grating 44 and the groove in the cap 46 once air is removed from the gap. After the cap 46 is secured on the substrate 30, the fiber grating 44 is inserted into the groove of the cap 46 as shown in FIG. 5. After the fiber grating 44 is inserted into the groove of the cap 46, the electrodes 38 respectively connected to the heater elements 36 are bonded via wires to the terminals 42 as shown in FIG. 6. If the cap 46 is correctly positioned relative to the heater elements 36, the fiber grating 44 can be correctly positioned on the heater elements 36. The fiber grating 44 may be disposed on the heater elements 36 first, followed by covering the cap 46 on the fiber grating 44.

FIG. 7 shows an example of an ideal temperature distribution in the fiber grating 44. The plural heater elements 36 are referred to as elements 36-1, 36-2, . . . , 36-n. Adjustment of the amounts of currents fed to the heater elements 36-1 through 36-n is possible to form a linear temperature distribution in the fiber grating 44. The linear temperature distribution exhibits the highest temperature at the location of the element 36-1 and the lowest temperature at the location of the element 36-n. In FIG. 7, a dashed line depicts a temperature distribution in the fiber grating 44 when the heater elements 36 are not energized and a solid line depicts a temperature distribution in the fiber grating 44 when the heater elements 36 are energized.

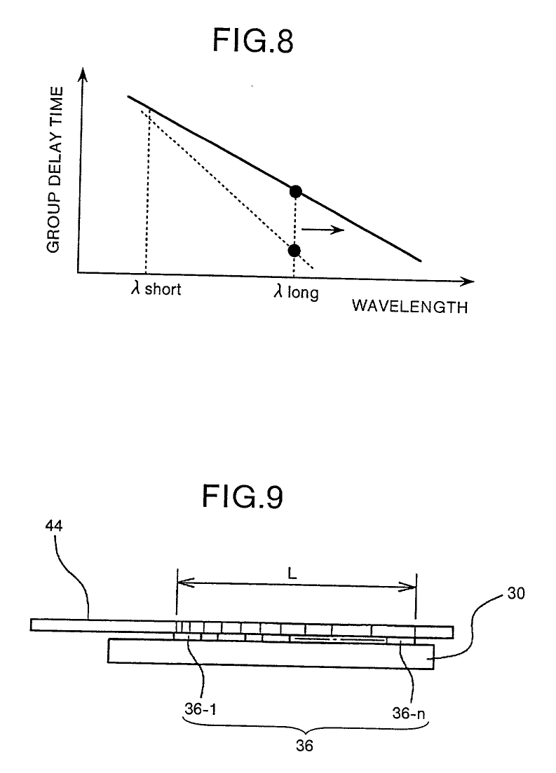

FIG. 8 shows a group delay time related to a wavelength of the optical signal when the linear temperature distribution shown in FIG. 7 is imparted on the fiber grating 44. If the fiber grating 44 has a higher temperature in a part, the part has an increased refractive index and an increased Bragg reflection wavelength λB. The increased Bragg reflection wavelength λB invites a lengthened path and an increased group delay time into the part. A longer part in the grating pitch Λ can be assumed at the higher temperature side and a shorter part in the grating pitch Λ at the lower temperature side. In this case, a shorter wavelength component λshort has a group delay time substantially unchanged and a longer wavelength component λlong has a group time delay increased.

The dispersion in the optical signal can be compensated accurately when a linear temperature distribution is imparted on the fiber grating 44, for example.

FIG. 9 shows a configuration of the heater elements 36 disposed within a grating range L in the fiber grating 44. The plural heater elements 36-1, 36-2, . . . , 36-n are arranged over the full length of the grating range L. For example, the heater element 36-1 is located at the end of the long wavelength in the grating range L and the heater element 36-n at the end of the short wavelength in the grating range L. The heater controller 22 is employed to feed a current to each of the heater elements 36-1, 36-2, . . . , 36-n to impart a temperature distribution on the fiber grating 44.

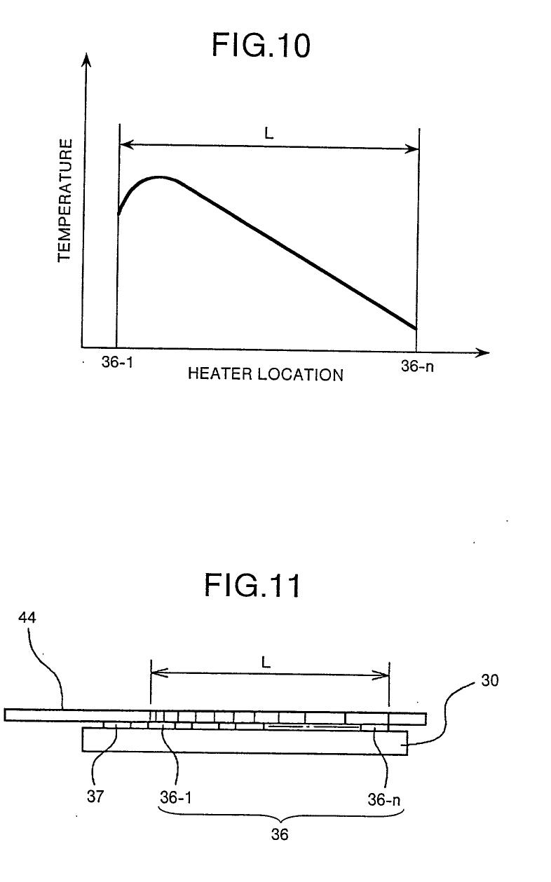

FIG. 10 shows an actual temperature distribution in the fiber grating 44 when linearly decreasing current values are given to the plural heater elements 36-1, 36-2, . . . , 36-n. When linear variations in current values are given to the plural heater elements, ideally the temperature distribution in the fiber grating 44 also exhibits linearity. That is, the highest temperature appears at the location of the heater element 36-1 and the lowest temperature at the location of the heater element 36-n, remaining a distribution of temperatures linearly decreasing therebetween. In the fiber grating 44 a location corresponding to a heater element sandwiched between other heater elements on both sides has a stable temperature (for example, a location corresponding to the heater element 36-2 or the heater element 36-3). Because a heat input from the higher temperature side interacts with a heat output to the lower temperature side. In contrast, no heat input from the higher temperature side is present at an end portion corresponding to the heater element 36-1 at the highest temperature side and a large temperature difference is present from a location provided with no heater, resulting in a sharp heat output. This obstructs exhibition of a linear temperature distribution at the portion corresponding to the heater element 36-1. Thus, a heat source is required to correct the non-linear temperature distribution into a linear temperature distribution at the heater location 36-1.

FIG. 11 shows a configuration of another FG heater unit 20. In contrast to FIG. 9, a sub-heater element 37 is formed on the substrate 30 in addition to the main heater elements 36-1, 36-2, . . . , 36-n. The sub-heater element 37 is arranged on an extension of the main heater elements 36 and located beyond the grating range L of the fiber grating 44. If the element 36-1 has the largest heating value among the main heater elements 36, the fiber grating 44 may have the highest temperature at the location corresponding to that element. In this case, the sub-heater element 37 is arranged at a location adjacent to the heater element 36-1 that provides the highest temperature. The sub-heater element 37 is formed from the same material and shape as that of the main heater elements 36 and patterned in the same process as that for the main heater elements 36, for example. If the sub-heater element 37 is not present, the element 36-1 has no heat input and suffers a temperature variation due to a sharp heat output. When the sub-heater element 37 is subjected to heating, however, it allows heat to flow into the main heater element 36-1, suppressing the sharp temperature variation and stabilizing the temperature. The heating value of the sub-heater element 37 is controlled in the heater controller 22. The heater controller 22 assumes the sub-heater element 37 as part of the main heater elements 36 and linearly varies the current values for the sub-heater element 37 and the main heater elements 36.

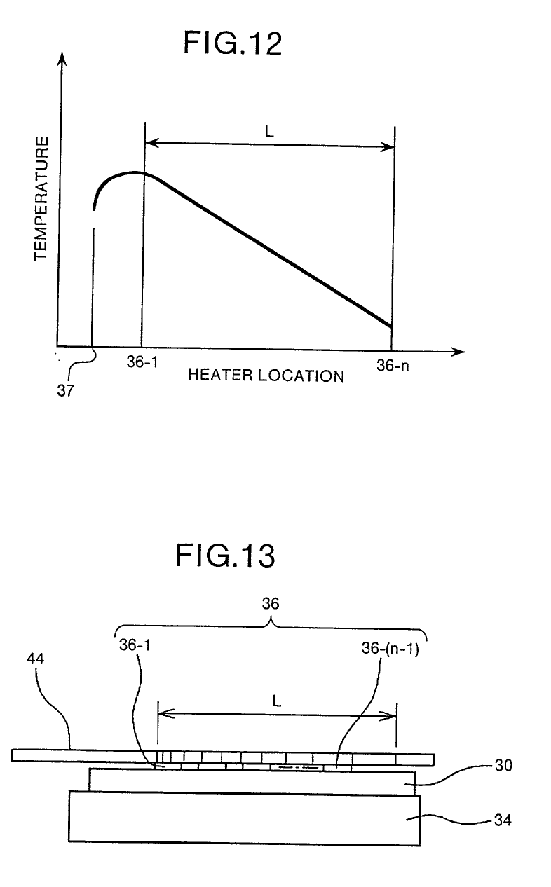

FIG. 12 shows a temperature distribution of the fiber grating in the FG heater unit 20 shown in FIG. 11. At a location in the fiber grating 44 corresponding to the element 36-1, heat from the sub-heater element 37 flows in and flows out to the lower temperature side. This can suppress a sharp temperature variation and achieve a linear temperature distribution over the grating range L. It is possible to express that the sub-heater element 37 functions as a main heater element extended beyond the grating range L. More precisely, it is possible to express that the sub-heater element 37 functions as a main heater element extended beyond the end at the higher temperature side of the grating range L to the outside of the grating range L.

FIG. 13 shows a configuration of another FG heater unit 20. In contrast to the FG heater unit shown in FIG. 9, the main heater elements 36 are not formed over the whole length of the grating range L in the fiber grating 44. Among the main heater elements 36, the elements 36-1, 36-2, . . . , 36-(n−1) are arranged on the substrate 30, lacking the element 36-n for providing the lowest temperature in the fiber grating 44. The Peltier unit 34 is located beneath the substrate 30 as shown in FIG. 3. The Peltier unit 34 can keep uniform and constant temperatures of the substrate 30 through production and absorption of heat. A temperature at a location provided with no heater element 36 in the fiber grating 44 is given from the temperature of the substrate 30. The temperature of the substrate 30 is controlled from the Peltier unit 34 and accordingly the lowest temperature in the fiber grating 44 is given from the Peltier unit 34. The heater controller 22 linearly varies the current values in the heater elements 36-1, . . . , 36-(n−1) to impart a linear temperature distribution on the fiber grating 44. The lowest temperature in the linear temperature distribution is given not from the heater elements 36 but from the Peltier unit 34. As the lowest temperature in the linear temperature distribution is not given from the heater elements 36, a power consumed at the heater elements 36 can be reduced. The configuration shown in FIG. 13 is equivalent to the configuration shown in FIG. 9 if the element 36-n for giving the lowest temperature in the fiber grating 44 is never energized. In the configuration shown in FIG. 9, however, if the element 36-n is not energized always, the significance of the presence of the element 36-n is lost, remaining an undesired constituent. The configuration shown in FIG. 13 precludes such the undesired constituent.

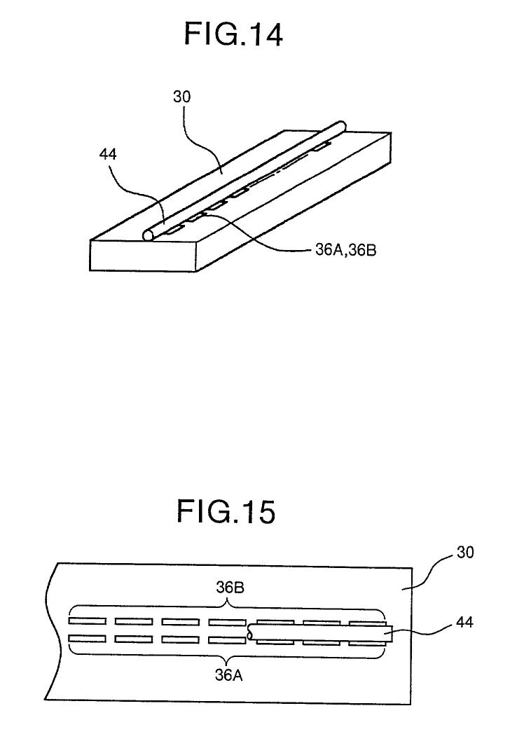

FIG. 14 and FIG. 15 show a configuration of a further FG heater unit 20. Two arrays of heater elements 36A, 36B are formed on the substrate 30 along the axis of the fiber grating 44. The heater elements 36A, 36B respectively consist of a plurality of elements and are spaced from each other by a certain distance. The fiber grating 44 is secured on the substrate 30 in contact with both the heater elements 36A and 36B. The heater elements 36A, 36B are connected to different electrodes via wired patterns. The heater controller 22 is employed to control the heater elements 36A and 36B individually. The heater controller 22 controls an amount of the current supplied to the heater elements 36A to impart a linear temperature distribution on the fiber grating 44. The heater controller 22 also controls an amount of the current supplied to the heater elements 36B to impart a non-linear temperature distribution on the fiber grating 44. The heater controller 22 energizes either of the heater elements 36A and 36B to set the temperature distribution in the fiber grating 44 in linear or non-linear. Alternatively, the heater controller 22 energizes both the heater elements 36A and 36B to create a temperature distribution in combination of linear and non-linear.

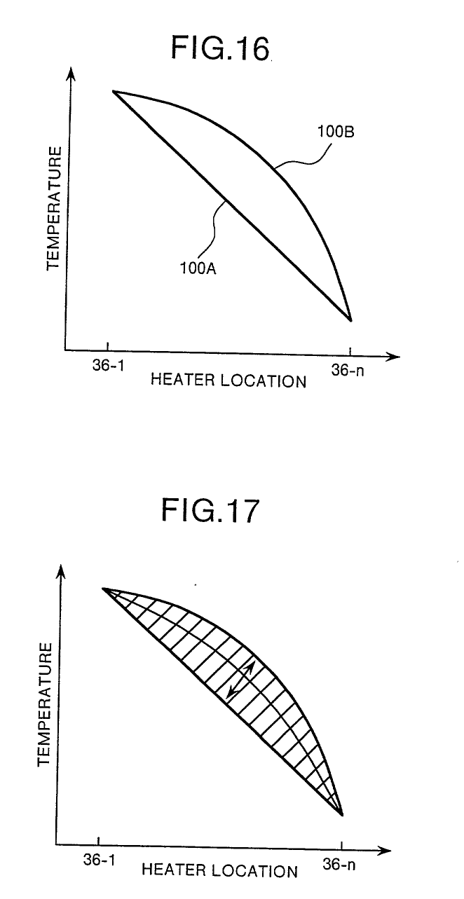

FIG. 16 shows a temperature distribution in the fiber grating 44 created by the heater elements 36A and 36B. The heater elements 36A and 36B both include elements 36-1, 36-2, . . . , 36-n. The heater controller 22 controls an amount of the current in the heater elements 36A to create a linear temperature distribution 100A. The heater controller 22 controls an amount of the current in the heater elements 36B to create a non-linear temperature distribution 100B. The heater elements 36A and 36B can be formed from thin film resistors of the same shape and material. The heater controller 22 can vary an amount of the current supplied to each element in the heater elements 36A, 36B linearly and non-linearly to create the temperature distributions 100A and 100B. The heater elements 36A may be shaped in a form suitable for creating the linear temperature distribution. The heater elements 36B may be shaped in a form suitable for creating the non-linear temperature distribution. Element intervals for constructing the heater elements 36B may be varied non-linearly to create the non-linear temperature distribution.

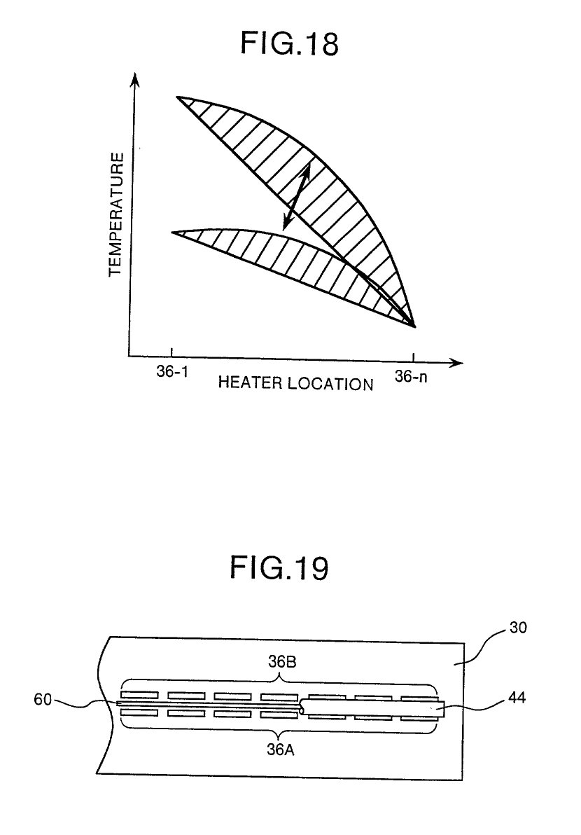

FIG. 17 and FIG. 18 exemplify temperature distributions in the fiber grating 44 created by the heater elements 36A and 36B in combination. When the heater elements 36A are energized as well as the heater elements 36B, a temperature distribution is formed in the fiber grating 44. This temperature distribution includes a linear temperature distribution and a non-linear temperature distribution added thereon, that is, a non-linear temperature distribution. The linear temperature distribution created by the heater elements 36A serves as a base temperature distribution. The non-linear temperature distribution created by the heater elements 36B serves as an additional temperature distribution. When the amount of the current in the heater elements 36B is increased or decreased while the amount of the current in the heater elements 36A is fixed, the additional non-linear temperature distribution is increased or decreased, resulting in a temperature distribution as a hatched part in FIG. 17. When the amount of the current in the heater elements 36A is increased or decreased while the amount of the current in the heater elements 36B is fixed, the linear temperature distribution is increased or decreased, resulting in a temperature distribution as a hatched part in FIG. 18. An arrow in FIG. 17 and FIG. 18 indicates a variable range of the temperature distribution. When the amounts of the currents in the heater elements 36A and the heater elements 36B are increased or decreased together, various temperature distributions can be created in the fiber grating 44. The heater elements 36A and 36B can be formed together on the substrate 30 or separately on individual substrates. Forming them on the individual substrates can suppress the heat exchange between the heater elements 36A and 36B. If the heater elements 36A and 36B are formed together on the substrate 30, a heat insulating material 60 may be suitably interposed between the heater elements 36A and 36B as shown in FIG. 19. The heat insulating material 60 can be integrated with the substrate 30.

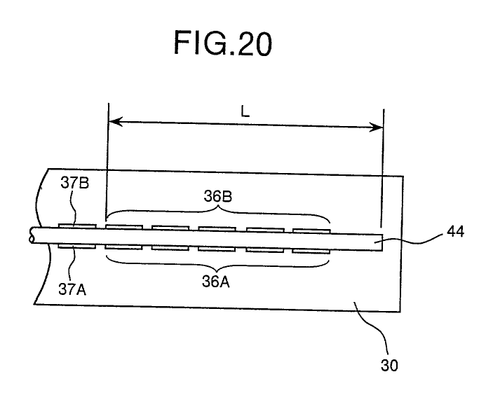

FIG. 11 shows the configuration provided with the sub-heater element 37, FIG. 13 shows the configuration not provided with a main heater element at the lowest temperature side, and FIG. 15 shows the configuration provided with two main heater elements 36A and 38B. These configurations can be applied to the FG heater unit 20 individually, but may be applied in combination of these three characteristics to the FG heater unit. FIG. 20 is a plan view which shows a FG heater unit 20 having these three characteristics. The main heater elements 36A and 38B are formed on the substrate 30 along the axis of the fiber grating 44. A sub-heater element 37A is formed on the extension of the main heater elements 36A and beyond the grating range L. Another sub-heater element 37B is formed on the extension of the main heater elements 36B and beyond the grating range L. The main heater elements 36A, 36B are not formed over the whole grating range L. They are not formed at the lowest temperature part in the fiber grating 44 (It should be noted that the main heater elements 36A, 36B are not formed at the right end of the fiber grating 44 in the figure).

According to the present invention, the use of heat radiated from the sub-heater element allows the heat input to interact with the heat output even at the end of the main heater elements, stabilizing the temperatures of the fiber grating.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A variable dispersion compensator comprising:
a substrate;
a fiber grating arranged on the substrate;
a plurality of main heater elements arranged along the axis of the fiber grating within a grating range of the fiber grating; and
a sub-heater element arranged beyond the grating range of the fiber grating for adjusting a temperature distribution in the fiber grating produced by the main heater elements.

2. The variable dispersion compensator according to claim 1, wherein the sub-heater element is located in a region in the temperature distribution where the temperature is the highest.

3. The variable dispersion compensator according to claim 1, wherein the sub-heater element adjusts the temperature distribution linearly over the grating range.

4. The variable dispersion compensator according to claim 1, further comprising a temperature control unit for varying the temperature distribution in the fiber grating by controlling power supplied to the main heater elements and the sub-heater element.

5. The variable dispersion compensator according to claim 1, further comprising a Peltier unit located on the lower surface of the substrate which evens temperatures of the substrate.

6. A variable dispersion compensator comprising:
a substrate;
a chirp grating arranged on the substrate;
a main heating unit arranged along the axis of the chirp grating within a grating range of the chirp grating; and
a sub-heating unit arranged beyond the grating range of the chirp grating.

7. The variable dispersion compensator according to claim 6, wherein the sub-heating unit is located in the vicinity of a part at the highest heating value in the main heating unit.

8. The variable dispersion compensator according to claim 6, wherein the sub-heating unit linearly compensates the temperature distribution produced by the main heating unit in the chirp grating.

9. A variable dispersion compensator comprising:
a substrate;
a fiber grating arranged on the substrate;
a plurality of first heater elements arranged along the axis of the fiber grating; and
a plurality of second heater elements arranged along the axis of the fiber grating and spaced from the first heater elements,
wherein the first heater elements impart a linear temperature distribution on the fiber grating, and the second heater elements impart a non-linear temperature distribution on the fiber grating.

10. The variable dispersion compensator according to claim 9, further comprising a heat insulating material located between the first and second heater elements.

11. The variable dispersion compensator according to claim 9, further comprising a temperature control unit which individually controls power supplied to the first and second heater elements.

12. The variable dispersion compensator according to claim 9, further comprising a Peltier unit located on the lower surface of the substrate which evens temperatures of the substrate.

13. A variable dispersion compensator comprising:
a substrate;
a chirp grating arranged on the substrate;
a first heating unit arranged along the axis of the chirp grating which creates a linear temperature distribution in the chirp grating; and
a second heating unit arranged along the axis of the chirp grating and spaced from the first heating unit which creates a non-linear temperature distribution in the chirp grating.

14. The variable dispersion compensator according to claim 13, further comprising a heat insulating unit located between the first and second heating unit.

15. The variable dispersion compensator according to claim 13, further comprising:
a first temperature control unit which controls power supplied to the first heating unit; and
a second temperature control unit which controls power supplied to the second heating unit independently from the power supplied to the first heating unit.

16. A variable dispersion compensator comprising:
a substrate;
a fiber grating arranged on the substrate; and
a plurality of heater elements arranged along the axis of the fiber grating in a region other than the region in the fiber grating where the temperature is the lowest.

17. The variable dispersion compensator according to claim 16, further comprising a temperature control unit which varies a temperature distribution in the fiber grating by controlling the power supplied to the heater elements.

18. The variable dispersion compensator according to claim 16, further comprising a Peltier unit located on the lower surface of the substrate which evens temperatures of the substrate and imparts the lowest temperature to the substrate.

19. A variable dispersion compensator comprising:
a substrate;
a chirp grating arranged on the substrate;
a heating unit which imparts a temperature distribution on the chirp grating except for the lowest temperature along the axis of the chirp grating; and
a substrate temperature control unit located beneath the substrate which evens temperatures of the substrate and imparts the lowest temperature to the substrate.

20. A substrate for a variable dispersion compensator, the substrate comprising:
a plurality of main heater elements arranged in line; and
a sub-heater element arranged in the vicinity of the main heater elements,
wherein the sub-heater element adjusts a temperature distribution in the fiber grating produced by the main heater elements.

21. The substrate for a variable dispersion compensator according to claim 20, where in the sub-heater element adjusts the temperature distribution linearly.

22. A substrate for a variable dispersion compensator, the substrate comprising:
a plurality of first heater elements arranged in line; and
a plurality of second heater elements arranged in parallel with and spaced from the first heater elements,
wherein the first heater elements impart a linear temperature distribution on the fiber grating, andthe second heater element impart a non-linear temperature distribution on the fiber grating.
